(19) United States
(12) Patent Application Publication
(10) Pub. No.: US 2011/0204811 A1
(43) Pub. Date: Aug. 25, 2011

(54) METHOD OF DRIVING A SHORT-ARC DISCHARGE LAMP

(75) Inventor: Jens Pollmann-Retsch, Aachen (DE)

(73) Assignee: KONINKLIJKE PHILIPS ELECTRONICS N.V., EINDHOVEN (NL)

(21) Appl. No.: 13/125,825

(22) PCT Filed: Oct. 20, 2009
(86) PCT No.: PCT/IB09/54604

§ 371 Date: Apr. 25, 2011

(30) Foreign Application Priority Data
Oct. 27, 2008 (EP) 08167596.9

(51) Int. Cl. H05B 41/39

(52) U.S. Cl. 315/271

(57) ABSTRACT

The invention describes a method of driving a gas-discharge lamp (1), wherein the lamp (1) is driven at any one time using one of a plurality of operating modules (M₁, M₂, M₃, M₄) and wherein a first operating mode (M₁) and a second operating mode (M₂) are applied successively during a lamp operating cycle, and the lamp (1) is driven according to the first operating mode (M₁) for a first fraction (f₁) of the cycle time (T) of the operating cycle and the lamp (1) is driven according to the second operating mode (M₂) for a second fraction (f₂) of the cycle time (T) of the operating cycle, and whereby the size of the first fraction (f₁) and the size of the second fraction (f₂) are calculated using a mixing ratio (r), which mixing ratio (r) is determined on the basis of a relationship between a cycle operating voltage value (U₁, U₂) and a target voltage (U_{T}). The invention further describes a driving unit (10) for driving a gas-discharge lamp (1) comprising a mixing ratio determining unit (17, 17′) for determining a mixing ratio (r′) on the basis of a relationship between a cycle operating voltage value (U₁, U₂) and a target voltage (U_{T}), a fraction calculating unit (15) for calculating the size of a first fraction (f₁) and the size of a second fraction (f₂) using the mixing ratio (r, r′), and an operating mode management unit (14) for selecting a first operating mode (M₃) and a second operating mode (M₂), from a plurality of operating modes (M₁, M₂, M₃, M₄), to be successively applied during a lamp operating cycle, such that the

### FIELD OF THE INVENTION

The invention describes a method of driving a gas-discharge lamp, and a driving unit for driving a gas-discharge lamp.

### BACKGROUND OF THE INVENTION

In gas discharge lamps such as HID (High Intensity Discharge) and UHP (Ultra-High Pressure) lamps, a bright light is generated by a discharge arc spanning the gap between two electrodes disposed at opposite ends of a discharge chamber of the lamp. In short-arc and ultra-short-arc (USA) discharge lamps, the electrodes in the discharge chamber are separated by only a very short distance, for example one millimetre or less. The discharge arc that spans this gap during operation of the lamp is therefore also short, but of intense brightness. Such lamps are useful for lighting applications requiring a bright, near point source of white light, for example spotlights used in indoor and outdoor filming, image projectors, or in automotive headlights.

When such a lamp is driven using alternating current (AC), each of the electrodes functions alternately as anode and cathode, so that the discharge arc alternately originates from one and then the other electrode. Ideally, the arc would always attach to the electrode at the same point, and would span the shortest possible distance between the two electrode front faces. However, because of the high temperatures that are reached during AC operation at high powers, the electrodes of a gas-discharge lamp are subject to physical changes, i.e. an electrode tip may melt or burn back, and structures may grow at one or more locations on the electrode tip at the point where the arc attaches to the tip. Such physical alterations to the electrode can adversely affect the brightness of the arc, since the arc may become longer or shorter, leading to fluctuations in the light output (flux) of the lamp. In the case of the lighting applications mentioned above, it is important for obvious reasons that the light output is not subject to unpredictable variations that might, for example, result in a noticeable flicker.

Therefore, a stable arc length is of utmost importance in certain lighting applications. Maintaining the light flux in modern projectors ultimately means maintaining a short arc-length for prolonged times. The arc length is directly related to the operating voltage of the lamp. This known relationship is used in some approaches to the problem, for example by switching between dedicated lamp operating modes or ‘driving schemes’ when the operating voltage reaches a predefined target voltage value. The lamp driving schemes serve to stabilise the arc length, and may include sophisticated combinations of different current wave-shapes and operating frequencies, designed so that alterations to the electrode tips are avoided where possible, or that the growing and melting of structures on the electrodes occur in a controlled manner. Depending on the choice of lamp driving scheme, modifications to the electrode surface can take effect within short to very short time-scales. In the known methods of lamp stabilization, voltage and/or time is monitored and the driving schemes are chosen accordingly to stabilize the arc-length by a more or less controlled growing and melting of structures on the tips of the lamp's electrodes. For example, in one type of operating mode or driving scheme, a controlled growing of structures on the lamp's electrode tips can be achieved by means of a known block shape of the lamp current upon which current-pulses are superimposed, directly preceding a commutation of the current. In a second mode of operation, a controlled melting back of the electrode front faces is achieved by driving the lamp at a higher frequency than in the first mode and without such a current-pulse superimposed on the current wave shape directly preceding the commutation of the current.

Typically, combinations of different current wave-shapes and operation frequencies are used to maintain the arc-length at a certain voltage value, or ‘target voltage’. The predefined target voltage for a lamp series can be determined for example during experiments carried out for a particular lamp type during the development stage. The target voltage can then be stored, for example in a memory of the lamp driver for use during operation of the lamp.

Although the known algorithms are capable of stabilizing the operating voltage (and therefore also the arc-length) of a UHP-lamp quite accurately, their application is nevertheless associated with several problems. Firstly, the existing solutions are often quite complex, i.e. they require algorithms of considerable complexity and are therefore also expensive, and they also require a large amount of information pertaining to a lamp in order to be able to correctly choose a set of parameters for the algorithms. Such information must usually be obtained prior to the actual operation of the lamp, for example in a product test phase for that lamp type.

Furthermore, the known methods strongly rely on the assumption that the properties of the lamp essentially do not change over the lifetime of the lamp. While this assumption may be justified in many cases, it also fails in many others, since for example the tungsten transport processes within the lamp strongly depend on impurities that are released from the lamp's components over its lifetime. Should the transport processes alter over the lifetime of the lamp, radical changes may also take place in the tip-growing and tip-melting for that lamp. In such a case, a fixed parameter set of the carefully balanced arc-length stabilization algorithm may lead to its failure.

Another problem is that some processes inside the lamp (e.g. the extent of tip-melting) are subject to chaotic influences, so that the sharp increase in voltage during tip-melting cannot be predicted with any accuracy. Such factors make it more difficult for a control algorithm with a predefined parameter set to operate effectively over long times, since minor fluctuations may result in significant effects if repeated often.

### SUMMARY OF THE INVENTION

Therefore, it is an object of the invention to provide an improved way of driving a short-arc lamp of the type described, to avoid the problems mentioned above.

The object of the invention is achieved by a method of driving a gas discharge lamp according to claim 1, and by a driving unit for driving the gas discharge lamp according to claim 12.

In the method of driving a gas discharge lamp, the lamp is driven at any one time using one of a plurality of operating modes. A first operating mode and a second operating mode are applied during a lamp operating cycle, and the lamp is driven according to the first operating mode for a first fraction of the cycle time of the operating cycle, and the lamp is driven according to the second operating mode for a second fraction of the cycle time of the operating cycle. Thereby, the size of the first operating cycle fraction and the size of the second operating cycle fraction are calculated using an operating cycle mixing ratio, which mixing ratio is determined on the basis of the relationship between a cycle operating voltage value and a target voltage.

Using the method according to the invention, the operating voltage of the gas discharge lamp can easily and effectively be stabilised by dynamically adapting the mixing ratio, i.e. the proportion of the cycle time assigned to the first and second operating modes (or ‘driving schemes’), to any changes in the lamp's behaviour, for example due to lifetime effects or external influences, as mentioned in the introduction. In this way, a quicker return towards the target voltage can be achieved by simply assigning a larger proportion of the cycle time to that operating mode that will bring the operating voltage of the lamp closer to the target voltage. A further advantage of the method according to the invention is that the only parameters it needs, in addition to the measured cycle operating voltage, are the cycle time and the target voltage. Since the latter two values—cycle time and target voltage—are values that easily can be predefined, the method according to the invention is much less complex, while at the same time more beneficial, than comparable prior-art approaches.

An appropriate driving unit for driving a gas discharge lamp comprises a mixing ratio determining unit for determining an operating cycle mixing ratio on the basis of a relationship between a cycle operating voltage value and a target voltage, and a calculating unit for calculating the size of a first operating cycle fraction and the size of a second operating cycle fraction using the mixing ratio. The driving unit according to the invention further comprises an operating mode select unit for selecting a first operating mode and a second operating mode, from a plurality of operating modes, to be successively applied during a lamp operating cycle, such that the lamp is driven according to the first operating mode for the first fraction of the cycle time of the operating cycle and the lamp is driven according to the second operating mode for the second fraction of the cycle time of the operating cycle.

The dependent claims and the subsequent description disclose particularly advantageous embodiments and features of the invention.

The ‘target voltage’ is the voltage about which the lamp should ideally operate, and is generally dependent on fixed parameters such as the lamp type, and on variable parameters such as the lamp's age. The term ‘cycle operating voltage value’ refers to a value representing an operating voltage of the lamp e.g. a value of voltage measured, for example across the electrodes of the lamp, at some point during an operating cycle, or an average or other combination of several operating voltage measurements. This ‘cycle operating voltage value’, therefore, provides a characteristic of the operating voltage behaviour of the lamp. For the sake of simplicity, the terms ‘operating voltage’ and ‘cycle operating voltage value’ can be used interchangeably in the following, without restricting the invention in any way.

The relationship between target voltage and a cycle operating voltage value can, for example, simply be defined by the difference between these two voltage values. In a fairly straightforward approach, the relationship between target voltage and operating voltage of the lamp could be determined at one or more predefined points in time, for example it could be determined some time after turning on the lamp, or it could be determined every ten minutes. The mixing ratio could then be adjusted accordingly for all subsequent operating cycles until the next measurement. However, the method according to the invention allows a more dynamic adjustment of mixing ratio, and therefore a much more rapid response to fluctuations in the internal lamp environment. Therefore, in a particularly preferred embodiment of the invention, the relationship between the cycle operating voltage value and the target voltage for the present operating cycle is applied to determine the mixing ratio for a subsequent operating cycle. In this way, information about the current status of the lamp, in particular the relationship between the actual operating voltage of the lamp and the target voltage can be used to influence the behaviour of the operating voltage in a subsequent operating cycle. This approach allows a continual correction, if necessary, of the operating voltage so that this can approach the target voltage. It should be pointed out here that the term ‘subsequent’ may preferably mean the next operating cycle, but since a certain amount of time may elapse in gathering operating voltage measurements and performing the calculations, it may be that the ‘old’ mixing ratio needs to be applied during the next one or maybe more operating cycles before the newly calculated mixing ratio is available, so that the term ‘subsequent operating cycle’ may be interpreted simply as a ‘later operating cycle’.

Depending on the operating mode being applied, the operating voltage of the lamp may increase or decrease. For example, a low-frequency pulsed mode is associated with a decrease in lamp voltage, while a high frequency non-pulsed mode is associated with an increase in lamp voltage. The choice of driving scheme or operating mode to apply can be based on criteria known to a person skilled in the art. Possible driving scheme parameters such as wave-shape, frequency etc. for a number of different driving schemes are described in WO 2005/062684 A1 or in EP07112156.0. In a further preferred embodiment of the invention, therefore, the first and second operating modes to be applied during the cycle time are chosen such that the overall slope of the operating voltage during the first operating mode is opposite in sign to the overall slope of the operating voltage during the second operating mode. In other words, within one operating cycle, a rise in operating voltage is followed by a fall in operating voltage. In this way, the method according to the invention ensures that the lamp voltage does not deviate too far from the target voltage in an operating cycle, since any increase in operating voltage is followed by a decrease in operating voltage, or vice versa.

As mentioned in the introduction, the tips of the electrodes in the gas discharge lamp are subject to changes such as tip melting and tip growth, depending on the operating mode being applied. State-of-the-art driving methods combine operating modes so that a melting of the electrode tips is compensated by a subsequent growing, so that, in the long term, the electrodes maintain their shape and size. Therefore, in a further preferred embodiment of the invention, the first and second operating modes are chosen such that one operating mode is associated with tip-growth, and the other operating mode is associated with tip-melting.

A part of the total cycle time of the operating cycle can be assigned to the operating modes, each of which is associated with one of the first and second fractions of the cycle time. Preferably, however, the sum of the first and second fractions is equal to the cycle time, so that the cycle time is divided up into only the first and second fraction.

The dynamic adaptation of the operating cycle mixing ratio according to the invention should preferably be performed so that the lamp voltage increases or decreases in the long-term in order to approach the target voltage. The degree by which the mixing ratio should be adjusted during operation of the lamp will depend to a large extent on the difference at any one instant between the lamp voltage and the target voltage. Therefore, in a particularly preferred embodiment of the invention, the relationship between a cycle operating voltage value and the target voltage comprises a measurement of deviation of the operating voltage value from the target voltage determined for the present operating cycle, and the mixing ratio for a subsequent operating cycle is determined on the basis of the mixing ratio used in the present operating cycle and on the measurement of deviation.

To determine the deviation of the operating voltage from the target voltage a number of approaches may be taken. A simple voltage deviation can be measured, and the instant at which this deviation is measured may be chosen in a number of ways. For example, the deviation can be measured at the beginning of an operating cycle, when switching over from one operating mode to the next operating mode, or at the end of the operating cycle. For this purpose, for example, the value of target voltage can be subtracted from the measured operating voltage value, or vice versa. Furthermore, the lamp voltage deviation from the target voltage can be measured any number of times during an operating cycle, depending on the level of effort that can be put into such measurements, or on the level of accuracy required.

In one approach, the lamp voltage is measured upon completion of the first operating mode in the present operating cycle, i.e. after the first fraction of the operating cycle time, and the measurement of deviation simply comprises the difference at that instant between the measured voltage value and the target voltage.

Alternatively, the lamp voltage can be measured upon completion of the second operating mode in the present operating cycle, i.e. after the second fraction of the operating cycle time, and the measurement of deviation in this case comprises the difference between the measured voltage value and the target voltage at that instant.

The measurement of deviation is then applied to determine the mixing ratio to apply in a subsequent operating cycle such that, over time, the deviation from the target voltage is lessened, which is simply another way of saying that the operating voltage approaches the target voltage.

Since the lamp voltage is closer to the target voltage after completion of an operating cycle, the instant at which the deviation measurement is obtained affects the development of the operating voltage relative to the target voltage. Obtaining the voltage deviation after completion of the first fraction or after completion of the second fraction means that, depending on whether the lamp voltage is approaching the target voltage from above or below, either the lowest points or the highest points of the voltage curve will lie close to the target voltage. This will be easier to visualise, later, with the aid of the Figures.

However, it may be desirable for the operating voltage to be ‘centred’ on the target voltage and not to lie above or below the target voltage, which would be the result of the alternatives explained above. In other words, the operating voltage of the lamp should preferably ‘oscillate’ about the target voltage. Therefore, in a particularly preferred embodiment of the invention, the first voltage value is measured upon completion of the first operating mode in the present operating cycle (after the first fraction of the operating cycle has elapsed), and the second voltage value is measured upon completion of the second operating mode in the present operating cycle (after the second fraction of the operating cycle has elapsed). A cycle average of these first and second measured voltage values is determined, and the measurement of deviation comprises the difference between the cycle average and the target voltage. The cycle average can be, for example, the simple average of the first and second measured voltage values. Using this preferred approach, the operating voltage can approach the target voltage and then remain effectively ‘centred’ on the target voltage.

To calculate the mixing ratio r′ for a subsequent operating cycle using the data measured during the present operating cycle, it is expedient to apply a linear relationship between time and voltage development. Assuming that the voltage deviation from the target voltage after the present operating cycle is to be compensated for in a subsequent operating cycle, the voltage deviation can be expressed as:

$$\frac{Δ {U}_{1}}{r \cdot T} \cdot {r}^{′} \cdot T + \frac{Δ {U}_{2}}{( 1 - r ) \cdot T} \cdot ( 1 - {r}^{′} ) \cdot T = - {U}_{dev} \qquad ( 1 )$$

Where U_{dev} is the deviation of the operating voltage from the target voltage determined as described above; T is the cycle time; r is the mixing ratio for the present operating cycle; ΔU₁ is the change in voltage over the first fraction, and ΔU₂ is the change in voltage over the second fraction. Since a negative value of time is not permissible, r′ should logically be restricted to the interval [0, 1]. Evidently, an operating cycle fraction with a value of 1 means that the corresponding operating mode should be applied over the entire operating cycle, and the other operating mode, whose operating cycle fraction therefore has a value of 0, will not be applied during that operating cycle. This may become necessary, for example, when the lamp operating voltage has departed too far from the target voltage, and a radical correction is necessary.

If the lamp voltage is measured upon completion of the first operating mode in the present operating cycle, the value of deviation can be expressed as

U_{dev}=d₁=u₁−U_{T} (1a)

Similarly, if the lamp voltage is measured upon completion of the second operating mode, the value of deviation can be expressed as

U_{dev}=d₂=U₂−U_{T} (1b)

In the same way, when a cycle average is obtained for the first and second measured voltage values, the value of deviation can be expressed as

U_{dev}=dₐᵥ=Uₐᵥ−U_{T} (1c)

Equation (1) can easily be solved for the new mixing ratio r′ to be applied in a subsequent operating cycle, expressed as follows:

$${r}^{′} = - \frac{{U}_{dev} + \frac{Δ {U}_{2}}{( 1 - r )}}{\frac{Δ {U}_{1}}{r} - \frac{Δ {U}_{2}}{( 1 - r )}} \qquad ( 2 )$$

As long as the voltage slopes of the operating modes are not too erratic in their behaviour, the method according to the invention can lead to a stabilisation of the operating voltage over the course of just a few operating cycles. Using the method according to the invention, the operating voltage can be brought very close to the target voltage, with only a minimal voltage spread observed in the long-term.

The cycle time for an operating cycle of the lamp is not restricted to a constant value, but can be changed during operation of the lamp. Since the control algorithm of the method according to the invention ultimately only determines the mixing ratio, it does not determine the absolute times for the operating modes applied during an operating cycle. Therefore, the cycle time can be altered during the operation of the lamp, for example to compensate for unforeseen large voltage fluctuations which may arise. The cycle time can be shortened or lengthened without adversely influencing the overall effectiveness of the control algorithm, and the method according to the invention continues to work well after only a short transition phase. For example, the cycle time could automatically be adapted to the actual deviation of the operating voltage from the target voltage. This can be useful when the deviation is relatively large, since, in such a situation, the lamp should be operated predominantly in one of the two operating modes in order to reduce the deviation over time. In fact, since the range of possible values for r′ includes 0 and 1, one of the fractions in a subsequent operating cycle can comprise the entire cycle time, so that only one operating mode is applied in that subsequent cycle. This may arise when the deviation from the target voltage is so large that a radical correaction is required.

Furthermore, the control algorithm offers flexibility in the choice of operating modes to use during an operating cycle. It is only preferable for the two operating modes applied in an operating cycle to have opposite signs in voltage slope, for the reasons already mentioned. It is not explicitly necessary for a particular effect to be associated with a particular operating mode, for example tip melting or tip growth. The method according to the invention continues to work well after a change in the operating modes being applied, again requiring only a short transition phase.

In a further development of the method according to the invention, to deal with the effects of larger voltage fluctuations or one-time events such as large voltage jumps, a running average can be determined for use in equation (2). For example, instead of simply using the difference operating voltage and target voltage over the first or second fractions, running averages can be computed for these voltage differences using measurements obtained in previous operating cycles. In a further development of equation (2), then, ΔU₁ can be the running average for the voltage change over the first fraction, and ΔU₂ can be the running average for the change in voltage over the second fraction. In the same way, U_{dev}, using equation (1a), (1b) or (1c) as appropriate, is obtained by calculating the running average for the deviation of the corresponding operating voltage from the target voltage. These values are then applied in equation (2) to give the new mixing ratio r′. The number of operating cycles over which these running averages are calculated can be chosen according to the available memory resources in the driving unit and according to the desired level of accuracy. For example, the running average could be calculated over the entire operation of the lamp since turning it on. Alternatively, in a more basic calculation, the running average could be determined using, for example, only the values for the present operating cycle and the values for a previous few operating cycles.

In a more sophisticated approach, the voltage changes ΔU of a plurality of operating cycles, measured over the entire operating cycle, could be stored together with their respective mixing ratios r. This data then can be used to determine a fitting function F (e.g., by a polynomial of higher order or by splines), expressed as follows:

ΔU=F(r) (3)

For each operating cycle, by using the measured actual voltage deviation from the target voltage as ΔU, the inverse of the fitting function F⁻¹ can then be used to compute the new mixing ratio r′. The advantage of such an approach is that, by using an appropriate type of fitting function F, a non-linear development in voltage over the cycletime T is also taken into consideration, in contrast to the linear approach of equation (1). Therefore, in a preferred embodiment of the invention, for a plurality of lamp operating cycles, full-cycle voltage deviations are recorded with their corresponding mixing ratios, and a fitting function is determined on the basis of the recorded values, and an updated mixing ratio for a subsequent operating cycle is determined using the fitting function.

Whenever the target voltage is reached, the ideal value of the updated mixing ratio would be the value for which the fitting function would become zero. In this ideal case, the lamp voltage, after each operating cycle, would return to the target voltage. However, in reality, perturbations will always disturb this perfect balance, for example imperfections in the lamp, alterations in the operating conditions, fluctuations in the driving current, etc. To obtain a high level of accuracy and reduce the influence of imperfections, deviation values and mixing ratios for a large number of preceding operating cycles are preferably stored in a non-volatile memory of the lamp's driving unit.

In a further preferred embodiment, an additional algorithm could be applied to automatically determine suitable operating modes to be used by the driving unit's control algorithm. As already mentioned, the voltage slopes of two operating modes of the control algorithm preferably have opposite signs. If for any reason (e.g. lifetime developments in the lamp), this requirement is no longer fulfilled by the two operating modes, a search for another set of suitable operating modes could be started. In such a search, alternative combinations of the operating frequencies and current waveforms used so far could be tested. The driving unit could, for example, determine the voltage slopes for several of such alternative operating modes and then select two operating modes (having voltage slopes of opposite sign) to be applied by the control algorithm from this point onwards. Examples of automatic selection rules might be that either operating modes with large voltage slopes (offering good leverage for voltage control) or with small values of voltage slopes (leading to small variations of the operating voltage around the target voltage) could be chosen. Due to the high level of flexibility of the method according to the invention, it does not matter in which order the operating modes are applied.

Depending on the number of operating modes to be tested, the search for new operating modes may require a few tens of seconds. The search could be initiated either when a certain condition is met (for example the voltage slope of one of the operating modes approaches zero, so that there is a risk that sooner or later both operating modes would have the same voltage slope sign), or could be applied regularly so that operating modes having significantly different slopes are preferably employed. To ensure that such control algorithm adjustments are not perceived by a user, the search could be initiated, for example, when a run-down phase commences before ultimately switching off the lamp. The new choice of operating mode is then applied the next time the lamp is turned on. Such an approach would be of particular advantage in applications such as projection, spot lighting, indoor and outdoor filming etc., that use gas discharge lamps such as ultra short-arc (USA) lamps, ultra high pressure (UHP lamps), or medium source rare-earth (MSR) lamps.

Another straightforward augmentation of the method according to the invention, which might be particularly useful with the operating mode search described above, could be to have more than two operating modes in use during operation of the lamp, for example in a fixed sequence, so that in one operating cycle, operating modes M₁ and M₂ are applied, and in a following operating cycle, operating modes M₃ and M₄ are applied, and this pattern is repeated to give the repeating sequence M₁, M₂, M₃, M₄, M₁, M₂, M₃, . . . . Such an approach could, for example, increase the probability that at least two voltage slopes with opposite signs will occur over the full repeating sequence.

The target voltage for a lamp can, in a particularly simple approach, be a predefined value obtained for example during experiments carried out in the developmeet of a lamp series. This target voltage value can be stored, for example in a memory of the driving unit of the lamp, and every time the lamp is turned on, the driving unit will endeavour to drive the lamp such that the lamp voltage lies in a region as close as possible to the target voltage. However, as mentioned above, the behaviour of the lamp can be subject to changes over the lifetime of the lamp, so that ultimately it may not be possible, or indeed desirable, for the lamp voltage to reach that value of target voltage. As the lamp ages, for example, it may be that a higher or lower target voltage is required. Therefore, in a particularly preferred embodiment of the invention, the target voltage is determined on the basis of an operation value obtained during operation of the lamp. Such an operation data value can be the lamp voltage itself, observed over time, or a value of pressure in the lamp, etc. The newly determined target voltage value is preferably stored in a non-volatile memory of the driving unit, so that it can be stored after the lamp is extinguished, and used as an initial target voltage the next time the lamp is turned on. In this way, the target voltage can also be dynamically adjusted whenever the necessity should arise.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a simplified schematic representation of the structural changes that take place on the tips of a pair of electrodes in a gas discharge lamp;

FIG. 2 shows a first graph, over a short time-span, of operating voltage of a gas discharge lamp driven using a method according to the invention;

FIG. 3 shows a second graph, over a short time-span, of operating voltage of a gas discharge lamp driven using a method according to the invention;

FIG. 4 shows a third graph, over a long time-span, of operating voltage of a gas discharge lamp, driven using a method according to the invention;

FIG. 5 shows a fourth graph of operating voltage of a gas discharge lamp, driven using a method according to the invention, with half the cycle time of FIG. 2;

FIG. 6 shows a fifth graph of operating voltage of a gas discharge lamp, driven using a method according to the invention, over a time-span during which the cycle time was increased by a factor of three;

FIG. 7 shows a sixth graph of operating voltage of a gas discharge lamp, driven using a method according to the mention, over a time-span during which the choice of operating modes was changed;

FIG. 8 shows a gas-discharge lamp and a block diagram of a possible realisation of a driving unit according to the invention;

FIG. 9a shows a block diagram of a first realisation of a control unit for the driving unit of FIG. 8;

FIG. 9b shows a block diagram of a second realisation of a control unit for the driving unit of FIG. 8;

FIG. 10 shows a gas discharge lamp and driving unit incorporated in a lighting system according to an embodiment of the invention.

In the drawings, like numbers refer to like objects throughout. Objects in the diagrams are not necessarily drawn to scale.

### DETAILED DESCRIPTION OF THE EMBODIMENTS

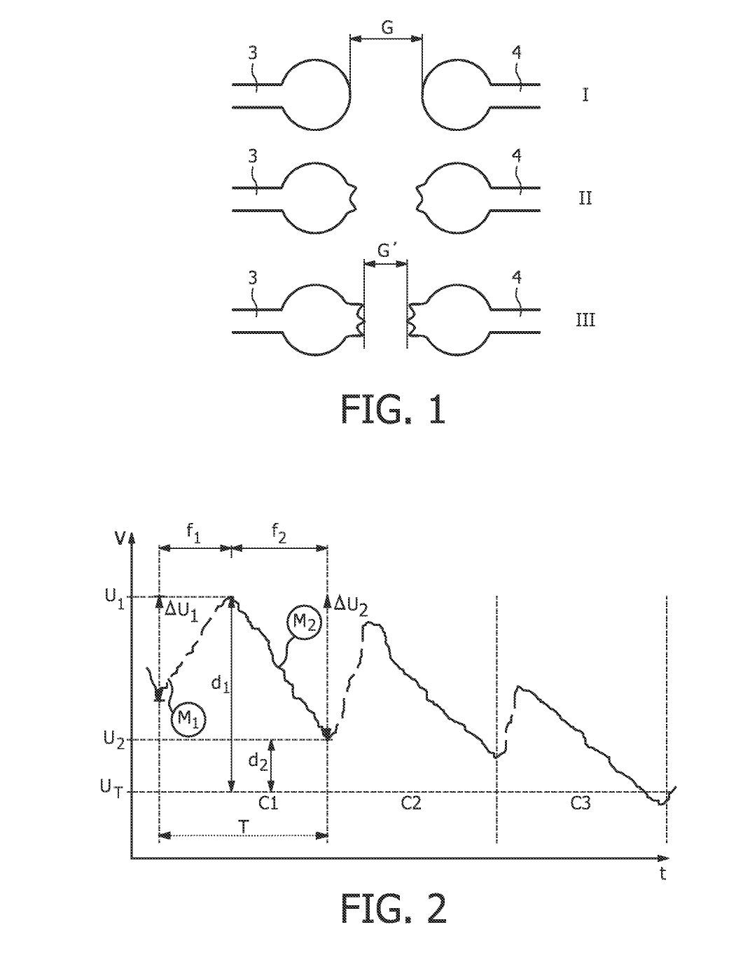

FIG. 1 shows a pair of electrodes 3, 4 separated by a gap G. Electrodes 3, 4 are disposed in a gas discharge lamp, not shown in the diagram, and face each other over this short gap G. In a first stage (I), the front faces of the electrodes shown in this example are essentially round, and do not display any structural unevenness. In a second stage (II), after the lamp has been operated for some time, the front faces of the electrodes show that ‘tips’ have begun to develop. Depending on the operating mode being applied to the lamp, tip-growth can progress (III) such that the gap between the electrodes is reduced to the smaller distance G′. The decrease in distance between the electrode front faces results in a drop in operating voltage. By applying an appropriate driving scheme or operating mode, these tips or structural changes to the electrode faces can be melted back so that the front faces of the electrodes are restored to their essentially round shape as shown in the first stage (I) of this explanatory Figure.

FIGS. 2-7 show graphs of operating voltage over time for lamps driven using the method according to the invention, under application of equation (2) to dynamically determine the operating cycle mixing ratio.

FIG. 2 shows a first graph of operating voltage over time for a lamp driven using a method according to the invention. It is desired that the operating voltage of the lamp approaches a target voltage U_{T}. A pair of operating modes has been chosen, with a first operating mode having a positive overall slope, and the second operating mode having a negative overall slope. The operating modes are applied in an alternating manner in successive operating cycles C1, C2, C3. In this Figure, for the sake of illustration, only three consecutive operating cycles C1, C2, C3 are shown, and each have the same cycle time T.

In the first operating cycle C1, the first operating mode is applied during a first fraction f₁ of the cycle time T, and the second operating mode is applied during the second fraction f₂ of the cycle time T. In this example, the first operating mode is associated with tip-melting and therefore also with an increase in operating voltage, so that the operating voltage of the lamp increases by an amount ΔU₁ after commencement of the operating cycle during the first fraction f₁ of the cycle time T. The second operating mode is associated with tip-growth, and therefore a drop in operating voltage, so that the operating voltage of the lamp decreases by an amount ΔU₂ during the second fraction f₂ of the cycle time T. The sizes of the first and second fractions of the cycle time are determined by a mixing ratio. The mixing ratio to be applied during the first operating cycle C1 can have been determined using one of the techniques described above, for example using equations (1) and (2). The operating voltage of the lamp can be measured when the first operating mode has completed, to give an operating voltage value U₁, and the corresponding deviation d₁ from the target voltage U_{T} can be determined. Similarly, the operating voltage of the lamp can be measured upon completion of the second operating mode to give an operating voltage value U₂, and the corresponding deviation d₂ from the target voltage U_{T} can be determined. One or both of these observed deviations d₁, d₂ can then be used to calculate or compute the mixing ratio for the subsequent operating cycle C2, and so on. As time progresses, the operating voltage exhibits an overall decrease to approach the desired target voltage U_{T}.

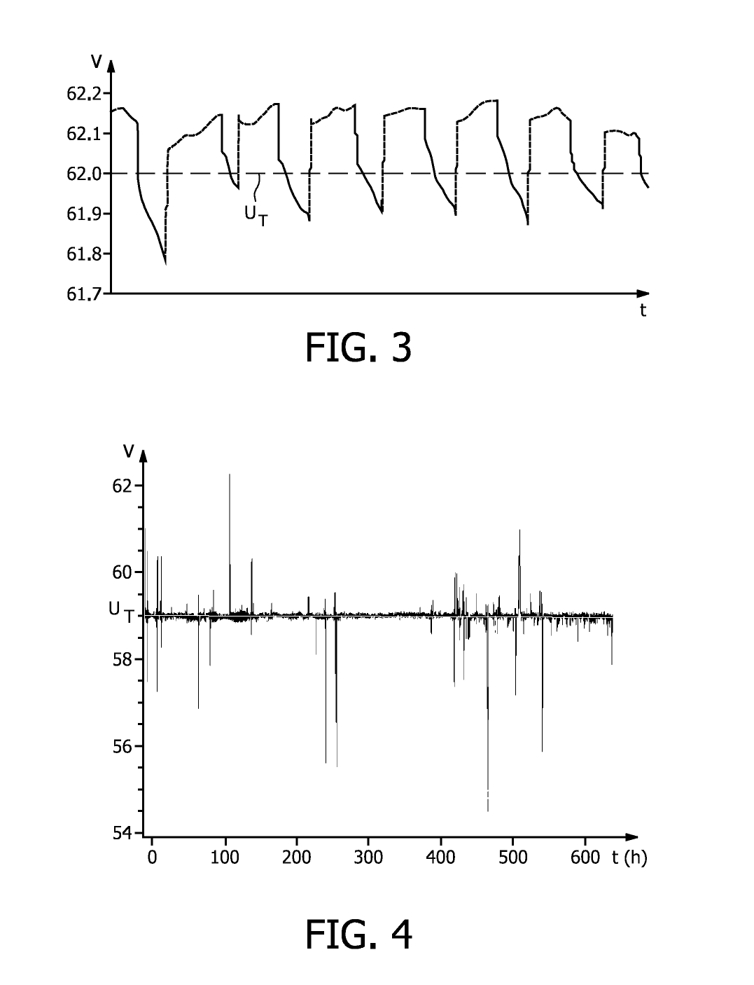

As long as conditions in the lamp remained fairly stable, the operating voltage will ultimately settle in a region near the target voltage, depending on the method or technique applied in calculating the mixing ratio for the operating modes. If equation (2) is used together with either equation (1a) or (1b), i.e. only one of the deviations d₁, d₂ is considered, the operating voltage will tend to remain either below or above the target voltage. Using equation (2) together with equation (1c), i.e. using the average of both deviations d₁, d₂, the operating voltage will tend to oscillate about the target voltage. FIG. 3 shows such an example for a lamp with a target voltage of 62V. Here, the mixing ratio was calculated using the average of the voltage deviations during each operating cycle, i.e. by applying equations (2) and (1c). This diagram clearly shows that the operating voltage oscillates about the target voltage level.

FIG. 2 and FIG. 3 showed only short timescales in the operation of a gas discharge lamp. In FIG. 4, the behaviour of the operating voltage and a lamp driven using the method according to the invention is shown over a much longer time scale, in this case over 600 hours. The lamp for which the operating voltage was measured in this case was a USA 132 W UHP lamp with a target voltage U_{T} of 59 V (corresponding to a short arc-length of about 0.7 mm). The voltage spread is very small, and the voltage of the lamp essentially lies at the desired voltage level. The spikes or outliers, typical of such a lamp, were quickly re-stabilized using the control algorithm according to the invention, as can clearly be seen in the diagram.

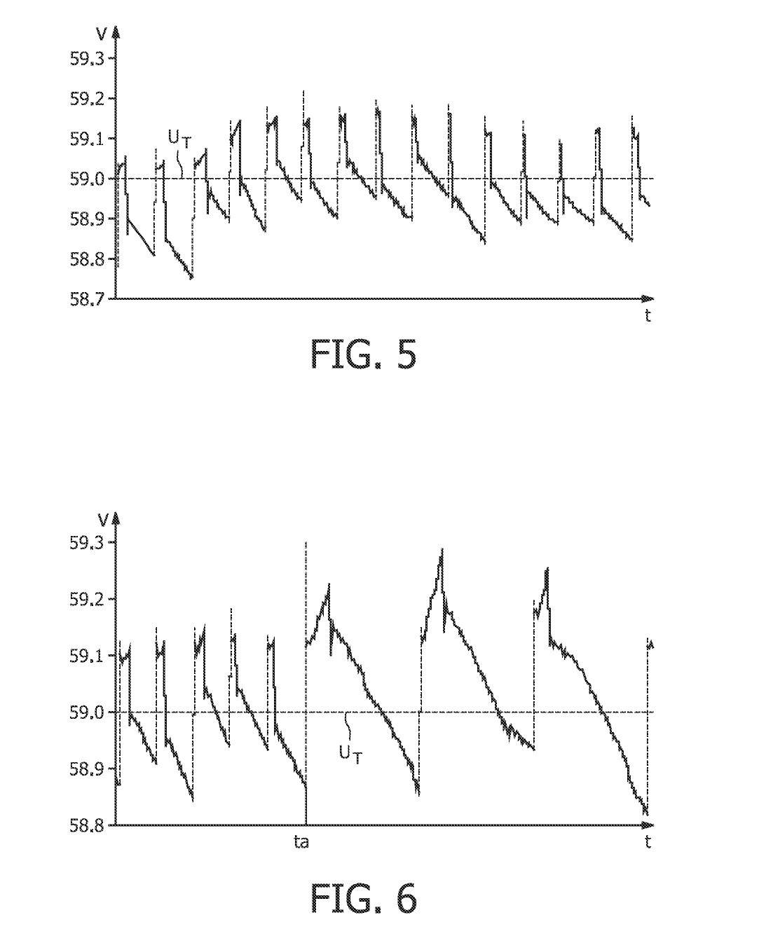

In FIG. 5, the effect of halving the cycle time compared to the results shown in FIGS. 2 and 3 can be seen. Again, the control algorithm according to the invention operated very well for this lamp with a target voltage U_{T} of 59 V, although the actual number of switches of the operating modes was doubled. This shows that the choice of cycle time does not significantly influence the effectiveness of the algorithm.

In fact, the cycle time can be altered even during operation of the lamp. This is shown in FIG. 6, which demonstrates the effect of tripling the cycle time while the lamp is burning. The alteration in cycle time occurred at the time tₐ indicated in the diagram. The control algorithm according to the invention continued to choose such values for the mixing ratio for each subsequent operating cycle so that the operating voltage was able to remain in the vicinity of the target voltage of 59 V.

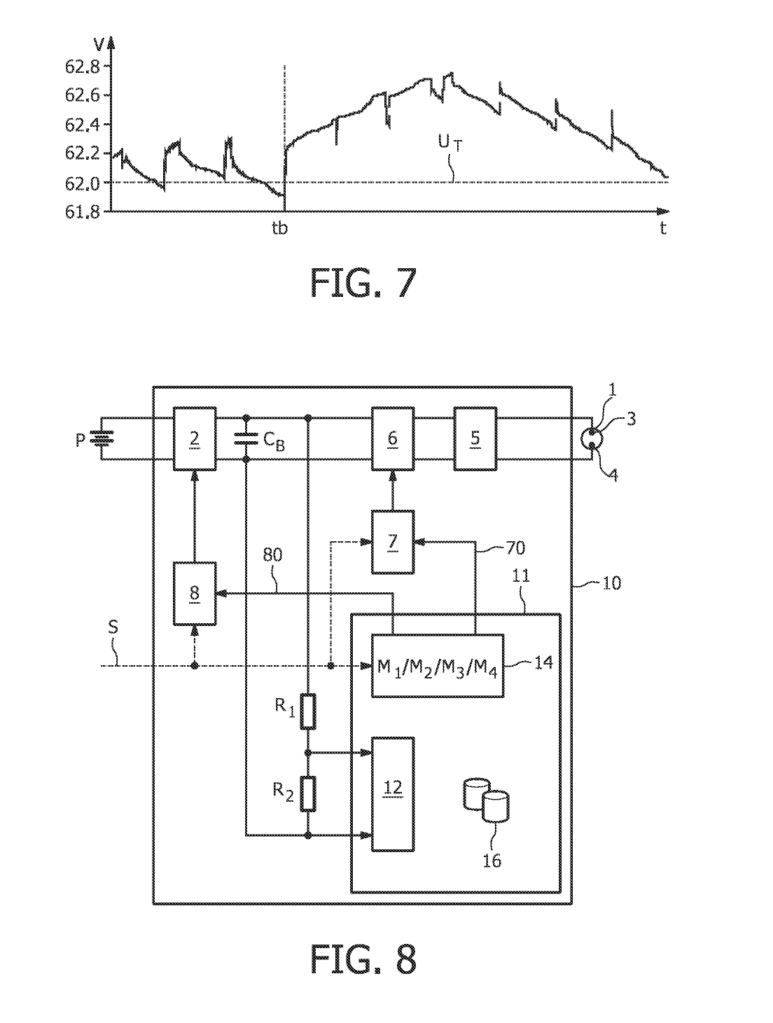

As mentioned in the description, it is preferable for two operating modes applied during an operating cycle to have opposite signs of overall voltage slope. In contrast to prior art algorithms mentioned in the introduction, the method according to the invention does not require that a particular operating mode effect is associated with a particular element in the control algorithm. The voltage slopes of the operating modes applied during a cycle time can be exchanged, without any negative effect on the control algorithm, which simply adjusts after a short transition phase. This can clearly be seen in FIG. 7, which shows that, at a time t_{b}, a radical change was made in the choice of operating modes being applied during the cycle times, leading to significantly different voltage slopes associated with the operating modes applied. Without any user intervention, the control algorithm was able to re-stabilize over a very short time by quickly adjusting the mixing ratios used in the subsequent operating cycles. After only a few operating cycles, the operating voltage had already returned to the neighbourhood of the target voltage of 62 V for this lamp.

FIG. 8 shows a gas discharge lamp 1 and a block diagram of one embodiment of a driving unit 10 according to the invention. The arrangement as shown can be used in a lighting system, for example, as part of a projection system.

The circuit shown comprises a power source P with a DC supply voltage, for example, 380V for a down converter unit 2. The output of the down converter unit 2 is connected via a buffer capacitor C_{B} to a commutation unit 6, which in turn supplies an ignition stage 5 by means of which the lamp 1 is ignited and operated. When the lamp 1 is ignited, a discharge arc is established between the electrodes 3, 4 of the lamp 1. The frequency of the lamp current is controlled by a frequency generator 7, and the wave shape of the lamp current is controlled by a wave forming unit 8. A control unit 11, whose function will be explained in more detail below, supplies control signals 70, 80 to the frequency generator 7 and wave forming unit 8, respectively, so that the amplitude, frequency and wave-shape of the lamp voltage and current can be controlled according to the momentary requirements.

The voltage applied to the buffer capacitor C_{B} is additionally fed via a voltage divider R₁, R₂ to a voltage monitoring unit 12 in the control unit 11. This diagram shows the main components of the control unit 11, namely a voltage monitoring unit 12, an operating mode management unit 14 for selecting and applying operating modes M₁, M₂, M₃, M₄ during operation of the lamp, and a non-volatile memory 16. Obviously, the operating mode management unit 14 is not restricted to a limited number of operating modes, the operating modes M₁, M₂, M₃, M₄ indicated here are solely for the purposes of illustration.

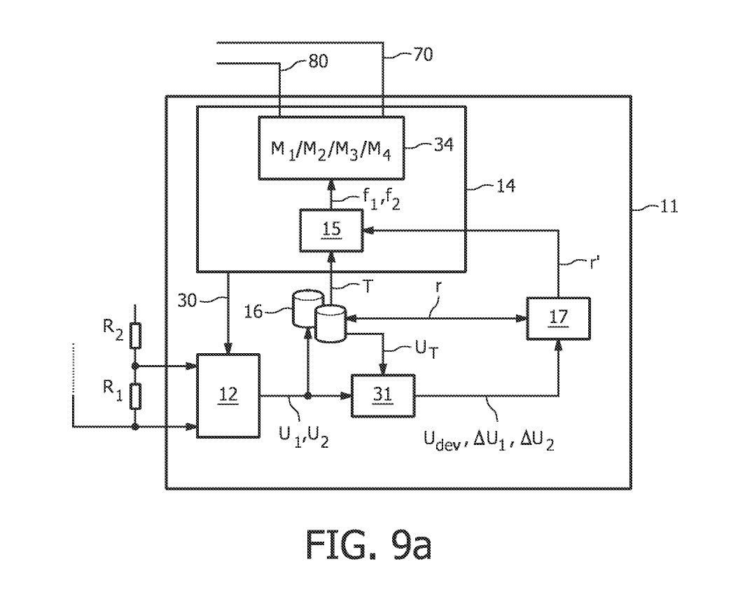

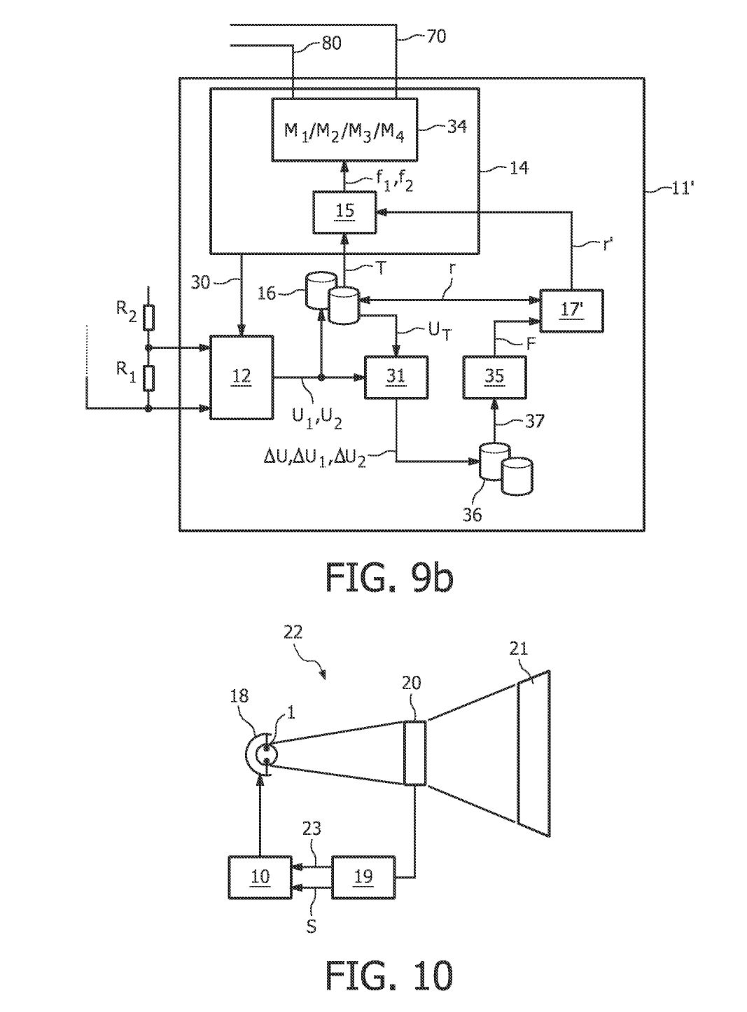

A detailed block diagram of the control unit 11 is shown in FIG. 9a. Here, the voltage monitoring unit 12 monitors the operating voltage of the lamp 1. The instants in time at which the voltage monitoring unit 12 is to measure the operating voltage is determined by a timing signal 30. For instance, the timing signal 30 can trigger a voltage measurement upon commencement of an operating cycle, or at the switch-over between operating modes during an operating cycle. The measured voltage values U₁, U₂ are stored in a non-volatile memory 16 and forwarded to deviation measurement unit 31 which uses a stored target voltage value U_{T} to determine a value of deviation U_{dev} for the present operating cycle and the voltage changes ΔU₁, ΔU₂ in the first and second fractions of the operating cycle. In this embodiment, the value of deviation U_{dev} is calculated using one of the techniques described earlier. Using the deviation value U_{dev}, the values of voltage change ΔU₁, ΔU₂, and the current mixing ratio r, a mixing ratio determination unit 17 determines a new mixing ratio r′ to be used during a following operating cycle by applying equation (2) together with equations (1a), (1b), or (1c) as appropriate.

The updated value of mixing ratio r′ is supplied to an operating mode management unit 14, which is also given the cycle time T stored in the non-volatile memory 16. Using this information, a fraction calculating unit 15 of the operating mode management unit 14 determines the sizes of the first and second fractions of the cycle time T in which first and second operating modes are to be applied in a following operating cycle. Accordingly, a control signal unit 34 of the operating mode management unit 14 supplies the appropriate signals 70, 80 to the frequency generator 7 and wave-shaping unit 8 respectively. The frequency generator 7 drives the commutation unit 6 at the appropriate frequency, and the wave-shaping unit 8 uses the down converter 2 to ensure that the correct current/pulse wave shape is generated for that chosen operating mode. The operating mode management unit 14 applies the information pertaining to the first and second fractions of the cycle time to generate the timing signal 30 to trigger voltage measurements at the appropriate instants in time during the following operating cycle.

FIG. 9b shows an alternative control unit 11′, in which the deviation measurement unit 31 supplies its measured voltage differences ΔU_{S}, ΔU₂, and/or the total voltage change ΔU=ΔU₁−ΔU₂ over the full cycle to a further non-volatile memory 36, which stores these values obtained over a plurality of operating cycles. The collected values are supplied as an appropriate signal 37 to a fitting function calculation unit 35, which in turn calculates a fitting function using these values. A suitable fitting function F can be retrieved by the mixing ratio determination unit 17′ which then applies the fitting function to determine the new value of mixing ratio r′ to supply to the operating mode management unit 14. The ‘new’ mixing ratio r is stored in the memory 16 for use in the next mixing ratio calculation.

The operating mode management unit 14 can also use the information it receives to determine whether to change the operating modes it has previously applied. For example, it may be expedient to use operating modes M₃, M₄ instead of operating modes M₁, M₂. To this end, the operating mode management unit 14 may also be supplied with further information, such as the measured voltage values U₁, U₂ and/or any or all of the deviation values ΔU₁, ΔU₂, ΔU. For the sake of clarity, this is not shown in the diagram.

Returning to FIG. 8, when the driving unit 10 is used in a projection system, a synchronisation signal S can be supplied from a projection system (not shown) to the driving unit 10, and distributed to the frequency generator 7, the wave-shaping unit 8 and the control unit 11, so that the lamp driver 10 can operate synchronously with, for example, a display unit or a colour generation unit of the projection system.

In the diagram, the memory 16, the operating mode management unit 14, the voltage monitoring unit 12, are all shown as part of the control unit 11. Evidently, this is only an exemplary illustration, and these units could be realised separately if required.

The control unit 11 or at least parts of the control unit 11, such as the operating mode management unit 14 can be realised as appropriate software that can run on a processor of the driving unit 10. This advantageously allows an existing lamp driving unit to be upgraded to operate using the method according to the invention, provided that the driving unit is equipped with the necessary wave-shaping unit and frequency generator. The driving unit 10 is preferably also equipped with a suitable interface (not shown in the diagram) so that an initial target voltage and any other desired parameters can be loaded into the memory 16 at time of manufacture or at a later time, for example when a different lamp type is substituted or a different performance is desired.

FIG. 10 shows a possible realisation of a lighting system according to the invention, in this case a projection system 22 with a lamp 1 mounted in a reflector 18 and controlled by a driving unit 10 as described above. Light emitted by the lamp 1 is cast in the usual manner at a display 20, for example an array of moveable micro-mirrors or a liquid crystal display, and projected onto a screen 21 for viewing. An image rendering control module 19 of the projection system 22 controls the display 20 and supplies the driving unit 10 with a synchronisation signal S and an information signal 23 to indicate shut-down or ignition phases to the driving unit 10.

The invention can preferably be used with all types of short-arc HIDlamps that can be driven with the method described above in applications requiring a stable arc (both axial and lateral), such as USA UHP lamps and MSR lamps, with applications in projection, as spotlights, headlights, for indoor and outdoor filming, etc. Although the present invention has been disclosed in the form of preferred embodiments and variations thereon, it will be understood that numerous additional modifications and variations could be made thereto without departing from the scope of the invention. It is also conceivable that a lamp driver could manage several different target voltages for a lamp, and can apply a particular target voltage according to the conditions under which the lamp is being driven at any one time. Each of these target voltages can be used in any of the methods described above.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1. A method of driving a gas-discharge lamp (1), wherein the lamp (1) is driven at any one time using one of a plurality of operating modes (M₁, M₂, M₃, M₄) and wherein
a first operating mode (M₁) and a second operating mode (M₂) are applied successively during a lamp operating cycle, and
the lamp (1) is driven according to the first operating mode (M₁) for a first fraction (f₁) of the cycle time (T) of the operating cycle and the lamp (1) is driven according to the second operating mode (M₂) for a second fraction (f₂) of the cycle time (T) of the operating cycle, and whereby
the size of the first fraction (f₁) and the size of the second fraction (f₂) are calculated using a mixing ratio (r),
which mixing ratio (r) is determined on the basis of a relationship between a cycle operating voltage value (U₁, U₂) and a target voltage (U_{T}).

2. A method according to claim 1, wherein the relationship between the cycle operating voltage value (U₁, U₂) and the target voltage (U_{T}) for the present operating cycle is applied to determine the mixing ratio (r′) for a subsequent operating cycle.

3. A method according to claim 1, wherein the first and second operating modes (M₁, M₂) to be applied during a cycle time (T) are chosen such that the overall slope of an operating voltage during the first operating mode (M₁) is opposite in sign to the overall slope of the operating voltage during the second operating mode (M₂).

4. A method according to claim 1, wherein the first and second operating modes (M₁, M₂) to be applied during a cycle time (T) are chosen such that one of the operating modes (M₁, M₂) is associated with tip-growth of the electrodes (3, 4) of the lamp (1) and the other operating mode (M₁, M₂) is associated with a tip-melting of the electrodes (3, 4) of the lamp (1).

5. A method according to claim 1, wherein the sum of the first and second fractions (f₁, f₂) equals the cycle time (T).

6. A method according to claim 1, wherein the relationship between a cycle operating voltage value (U₁, U₂, Uₐᵥ) and the target voltage (U_{T}) comprises a measurement of deviation (d₁, d₂, dₐᵥ) of the cycle operating voltage value (U₁, U₂, Uₐᵥ) from the target voltage (U_{T}) determined for the present operating cycle, and the mixing ratio (r′) for a subsequent operating cycle is determined on the basis of the mixing ratio (r) for the present operating cycle and the measurement of deviation (d₁, d₂, dₐᵥ).

7. A method according to claim 6, wherein a voltage value (U₁) is measured upon completion of the first operating mode (M₁) in the present operating cycle, and the measurement of deviation (d₁) comprises the difference between the measured voltage value (U₁) and the target voltage (U_{T}).

8. A method according to claim 6, wherein a voltage value (U₂) is measured upon completion of the second operating mode (M₂) in the present operating cycle, and the measurement of deviation (d₂) comprises the difference between the measured voltage value (U₂) and the target voltage (U_{T}).

9. A method according to claim 6, wherein a first voltage value (U₁) is measured upon completion of the first operating mode (M₁) in the present operating cycle, a second voltage value (U₂) is measured upon completion of the second operating mode (M₂) in the present operating cycle, a cycle average (Uₐᵥ) of the first and second measured voltage values (U₁, U₂) is determined, and the measurement of deviation (dₐᵥ) comprises the difference between the cycle average (Uₐᵥ) and the target voltage (U_{T}).

10. A method according to claim 1, wherein, for a plurality of lamp operating cycles, voltage changes over the entire operating cycles are recorded with the corresponding mixing ratios, and a fitting function (F) is determined on the basis of the recorded values, and a mixing ratio (r′) for a subsequent operating cycle is determined using the fitting function (F).

11. A method according to claim 1, wherein the target voltage (U_{T}) is determined on the basis of an operation data value (D) obtained during operation of the lamp (1).

12. A driving unit (10) for driving a gas-discharge lamp (1) comprising
a mixing ratio determining unit (17, 17′) for determining a mixing ratio (r′) on the basis of a relationship between a cycle operating voltage value and a target voltage (U_{T}),
a fraction calculating unit (15) for calculating the size of a first fraction (f₁) and the size of a second fraction (f₂) using the mixing ratio (r, r′),
an operating mode management unit (14) for selecting a first operating mode (M₁) and a second operating mode (M₂), from a plurality of operating modes (M₁, M₂, M₃, M₄), to be successively applied during a lamp operating cycle, such that the lamp (1) is driven according to the first operating mode (M₁) for the first fraction (f₁) of the cycle time (T) of the operating cycle and the lamp (1) is driven according to the second operating mode (M₂) for the second fraction (f₂) of the cycle time (T) of the operating cycle.

13. A driving unit (10) according to claim 12, comprising a memory unit (16, 36) for storing lamp-related data (U₁, U₂, r, ΔU₁, ΔU₂, ΔU) collected during operation of the lamp (1).

14. A lighting system (22) comprising a gas-discharge lamp (1) and a driving unit (10) according to claim 12.
